(19) United States
(12) Patent Application Publication
(10) Pub. No.: US 2017/0011381 A1
(43) Pub. Date: Jan. 12, 2017

(54) ELECTRONIC TRANSACTION METHOD AND SYSTEM VIA A PORTABLE ACCESSORY

(71) Applicant: GEMALTO SA, Meudon (FR)

(72) Inventors: Thierry SILVESTRE, Gemenos (FR); Daniel RADE, Gemenos (FR); Sebastien BALOCCO, Gemenos (FR)

(73) Assignee: GEMALTO SA, Meudon (FR)

(21) Appl. No.: 15/119,668

(22) PCT Filed: Feb. 16, 2015
(86) PCT No.: PCT/EP2015/053232

§ 371 Date: Aug. 17, 2016

(30) Foreign Application Priority Data
Feb. 18, 2014 (EP) 14305225.6

(51) Int. Cl. G06Q 20/32; G06F 9/445; G06Q 20/40; G06Q 20/10

(52) U.S. Cl. CPC G06Q 20/3226; G06Q 20/3278; G06Q 20/108; G06F 8/61; G06Q 20/4012

(57) ABSTRACT

The invention relates to a method for carrying out an electronic transaction between a main communication apparatus and a transaction terminal, wherein a smart portable accessory is provided, which has a different format from a standardized chip card format and is capable of relaying the transaction or of representing said main apparatus relative to a transaction terminal; and the transaction is carried out by only presenting said accessory, instead of the main apparatus, to the transaction terminal. The invention also relates to the corresponding system.

### FIELD OF THE INVENTION

The invention generally relates to a method for carrying out an electronic transaction between a main or an accessory communication apparatus and a transaction terminal.

In particular, it relates to the field of communication methods using a communication apparatus equipped with antitheft means.

### PRIOR ART

Electronic transactions in a broad sense can be carried out using radio frequency communication apparatuses such as radio frequency bank cards, electronic tags (RFID), electronic badges, electronic passports, communicating accessories.

Carrying out a radio frequency electronic transaction for a payment, an identification, access or any other purpose using a mobile phone (hereinafter referred to as an apparatus or a device) equipped with a radio frequency NFC (Near Field Communication) function is now possible.

Such transactions typically require taking out the radio frequency apparatus and the latter is exposed to being stolen during the transaction. Besides, taking the apparatus out of the place, bag, wallet, or clothing it is stored in may be a stress.

Associating watches having a NFC (Near Field Communication) function with mobile phones is known. The watches can be paired with a phone via NFC and then telephone calls can be received by the phone which can then return same to the watch via Bluetooth. Taking the phone out of a pocket then becomes unnecessary as the telephone communication can be made using the watch. The NFC function of the watch is only used to perform pairing with the phone so that both apparatuses can communicate together via Bluetooth™ to relay a call in progress. The watch only performs exchanges with the phone for communicating phone data, voice data, images, SMS.

The capabilities of the watch are relatively limited and depend on the phone for the operation thereof.

### Technical problem

The invention thus aims at remedying at least one of the drawbacks of the prior art. More particularly, the invention mainly aims at providing a practical solution to carry out a radio frequency electronic transaction without the risk of the radio frequency apparatus being stolen.

Besides, controlling or limiting the implementation of the transaction applications which may be ill-suited or oversized for a user such as an adult banking application with a high amount of money authorized per week as compared to same being used by a child with a lower amount of money allowed, may be needed. For example, it may be desired to increase transaction security or to prevent the carrying out thereof if an apparatus capable of carrying out electronic transactions has been stolen.

### SUMMARY OF THE INVENTION

The principle of the invention relies on using a radio frequency accessory discreetly hidden in a common portable object (not a priori designed, specifically because of its size, for being used for a contactless transaction) such as a watch, a ring, a bracelet. This object is capable of relaying or of representing the radio frequency apparatus at least for a transaction or a period of time or in a certain way. The accessory is preferably initialized by the main portable transaction apparatus or device.

Preferably, this accessory may be initialized, customized or configured using the main apparatus containing a transaction application. The accessory thus preferably comprises a different format from the standardized banking or payment chip card format.

For this purpose, the invention relates to a method for carrying out an electronic transaction between a main or accessory communication apparatus and a transaction terminal. The method is characterized in that it comprises the following steps:
providing a smart portable accessory capable of relaying the transaction or of representing said main apparatus relative to a transaction terminal,
carrying out the transaction by presenting said accessory instead of the main apparatus to the transaction terminal.

The invention thus makes it possible to avoid having to present the apparatus to a transaction terminal and to expose the main apparatus to third parties' views and theft risks.

According to other characteristics and/or advantages:
according to one embodiment, the method comprises a step of installing a banking application (AB) into the main apparatus, with the accessory transparently relaying the transaction between the main apparatus and the transaction terminal;
the method preferably comprises a step of initialization (or initiation) of the accessory using the main apparatus or of pairing the accessory using the main apparatus;
the step of initialization (or initiation) may comprise a phase of transfer/cloning of information selected from:
information IP on an electronic transaction application in the accessory and/or
information comprising a PIN code from the apparatus to the accessory;
the step of initialization/initiation may comprise a phase of launching an application for the driving of the accessory by the main apparatus;
the step of initialization/initiation may provide to capture a PIN code or the like required for a future transaction, via the main apparatus, and to transmit it safely to the accessory to enable a future or an in-progress transaction;
the accessory may be provided with communication means (FED) so configured as to relay data and control commands between the main apparatus and the terminal;
the transaction may be authorized by the user's voluntary action on a switch or a biometric authentication by the accessory. The accessory thus makes it possible to enhance the security of the transaction.
the method comprises a software application for controlling (AC) the implementation of a transaction software application (AB) particularly as regards a geographical area, a time period or how to complete the transaction. Thanks to the invention, the implementation of the transaction application which may be standardized and unchangeable can thus be controlled or completed, more particularly as regards security.

The invention also aims at providing a system for carrying out an electronic transaction between a main or accessory communication apparatus and a transaction terminal,

characterized in that it comprises:
a smart portable accessory which has a different format from a standardized chip card format, capable of relaying the transaction or representing said main apparatus relative to a transaction terminal,
communication and initialization/initiation means in the main apparatus to initialize/initiate the portable accessory and means for the communication of the accessory with a transaction terminal for carrying out the electronic transaction instead of the main apparatus, through the presentation of the accessory only to the transaction terminal.

### BRIEF DESCRIPTION OF THE FIGURES

Other characteristics and advantages of the invention will become apparent upon reading the following description given by way of illustrative and not restrictive example, with reference to the appended figures which represent:

FIG. 1 shows an electronic transaction diagram according to a first embodiment of the invention between a main apparatus and a transaction terminal via a relay portable apparatus;

FIG. 2 shows an electronic transaction diagram according to a second embodiment of the method of the invention using a portable accessory;

FIGS. 3 and 4 illustrate a smart portable accessory in the form of a watch respectively in the open and closed positions;

FIGS. 5 and 6 illustrate a smart portable accessory in the form of a bracelet respectively in the open and closed positions;

FIGS. 7 and 8 illustrate a smart portable accessory in the form of a ring respectively in the unlocked and locked or not worn/worn positions.

### DESCRIPTION

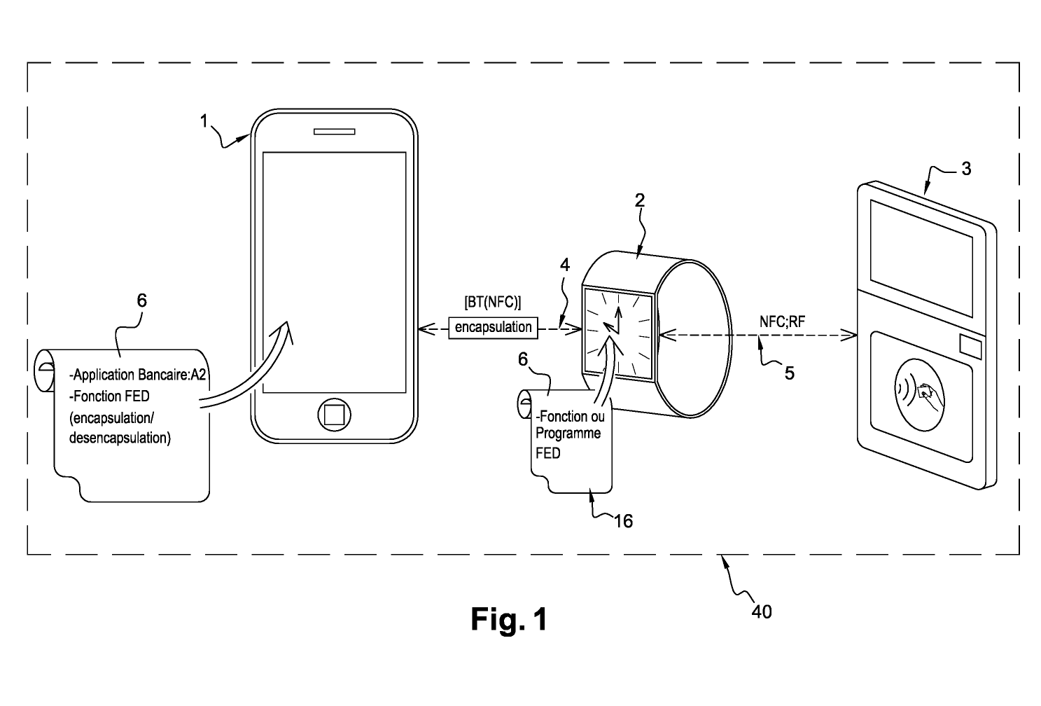

FIG. 1 illustrates a first embodiment of the method according to the invention for carrying out an electronic transaction between a main communication apparatus 1 and a transaction terminal 3. Transaction means any unidirectional or bidirectional exchange (data, commands, signals, messages . . . ) between two communication objects. Such exchanges can be for various purposes such as banking, identification, authentication, access, debit, credit . . . transactions.

A system 40 for carrying out a transaction consists of a main apparatus 1, an accessory 2 and a terminal 3. The main apparatus 1 here is a smart mobile phone, but can be any other smart object or apparatus such as a personal digital assistant (PDA), a lap-top (LP), or any other main portable communication apparatus. The exemplary apparatus specifically comprises μC processing means, (volatile and non volatile) storage means, at least one interface for communicating with an associated accessory (described below) and at least one interface for communicating with the transaction terminal 3 which may be the same as the previous one. Such communication interface can be of any type of technology such as Bluetooth (BT, WiFi, NFC, radio frequency Radio Frequency, UHF, optical, infrared . . . ) 4 to establish a communication with the accessory.

Preferably, the communication 4 between the main communication apparatus 1 and the relay accessory is of the Bluetooth™ type (hereinafter referred to as BT), whereas the one 5 between the relay accessory and the transaction apparatus is of the NFC, radio frequency radio frequency type, more particularly in compliance with the ISO 14443 standard.

The main communication apparatus 1 preferably comprises means providing a man/machine interface (MMI) with a user such as a keyboard 7, or a display 8. In the example, the display and the keypad are a touch screen and a touch pad. The apparatus 1 also comprises at least one transaction application 6 in an internal memory (SE) or an external mass storage such as a preferably secure mass memory card (Mini SIM, SD, micro SD) or a USB flash drive. In the example, the application is in a SIM card which is connected in a known manner to a NFC controller provided with a radio frequency interface.

In the case of the example, the transaction software application (AB) 6 is of the banking, financial, or payment type. This transaction application makes it possible to carry out an electronic transaction with the transaction terminal 3 such as a bank terminal (ATM, POS), an access point, a consumer goods vending machine . . .

The example relates to a portable payment terminal used as a proximity radio frequency reader of contactless cards or a mobile phone equipped with a NFC function and/or a contactless card emulation mode. According to an alternative solution, the phone or the apparatus may also not be provided with some capabilities, specifically radio frequency (NFC), which are included in a complementary manner in the accessory, thus adding interest to the accessory 2.

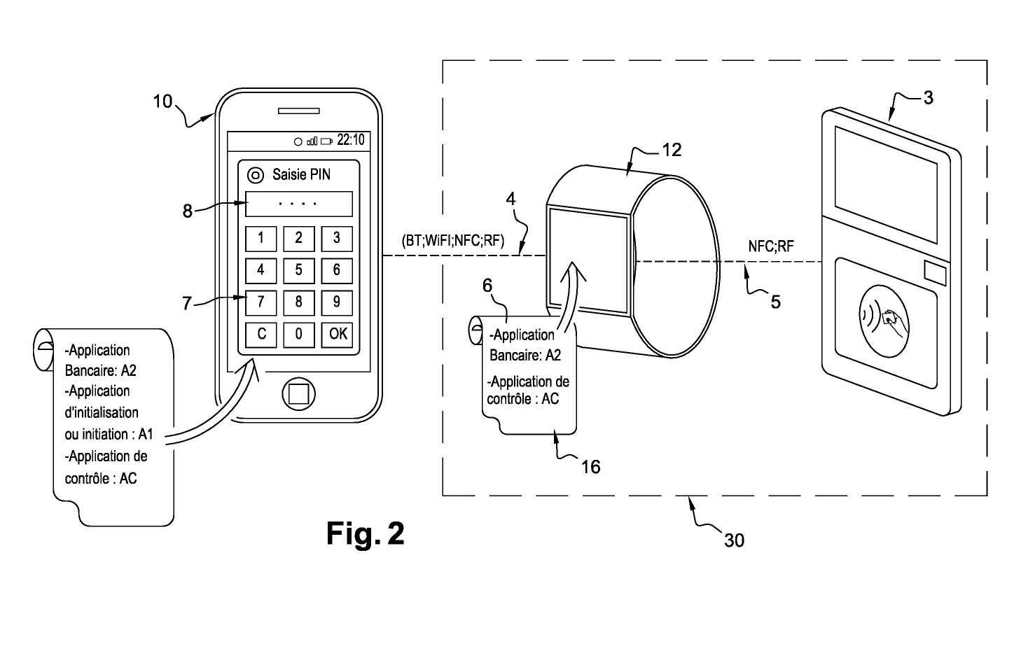

According to one embodiment, the invention comprises a step of providing a smart portable accessory 2. The latter, according to the embodiment shown in FIG. 1, is capable of relaying the transaction or according to the embodiment shown in FIG. 2, of representing said main apparatus relative to a transaction terminal.

For this purpose, the accessory 2 may comprise communication and interface means capable of converting a Bluetooth communication into a radio frequency communication. According to an alternative solution, the accessory can retrieve data or commands received from the main apparatus as radio frequency frames encapsulated in another communication protocol such as a Bluetooth protocol. In the example (FIG. 1), the accessory and the apparatus are so configured as to encapsulate and de-encapsulate radio frequency frames in Bluetooth type messages especially when they communicate with each other. Data or commands sent by the main apparatus 1 as radio frequency frames are thus received by the accessory being encapsulated in particular by the Bluetooth protocol and vice versa for those sent by the accessory to the main apparatus.

Data or commands received by the accessory can be decoded or de-encapsulated by the accessory prior to being sent back by the accessory or, in an alternate solution, temporarily stored in a memory of the accessory to be read by the transaction terminal. The accessory can either send back data and/or commands actively as they become available, or passively enable the reading thereof by the transaction terminal acting as a reader.

The data and/or commands from the main apparatus are received in and retrieved from the accessory and then read or transmitted through a communication 5 as frames to the radio frequency transaction terminal 3.

Thus, according to another characteristic or an alternative implementation, the method provides that the accessory has communication means so configured as to relay data and control commands between the main apparatus and the terminal.

Advantageously, the accessory 2 in the example, is an electronic watch comprising interface means with the transaction terminal 3 on the one hand, and with the main apparatus 1 as indicated above, on the other hand. The watch has a band to be worn around the wrist. The accessory may include buffer storage means for, at least temporarily, storing data and/or commands to be exchanged between the transaction terminal and the main apparatus. According to an alternative solution, the data and commands may not be stored but relayed when and as they reach it. The watch may include a watch case with a digital display or not, preferably a sensitive one, to interact with the user like in the apparatus 1.

According to an alternative solution, the communication between the main apparatus and the accessory may be of the electrical type through the body or on the surface of the skin. Capacitive means may be present in each of the apparatuses and accessories to collect the signal exchanges prior to retrieving information (data, commands) for processing purposes. According to an alternative solution too, the exchanges between the accessory and the terminal can be capacitive. The accessory may be so configured as to simply relay a capacitive, electric or any other signal. If necessary, the accessory may comprise means for amplifying the received signal with or without an energy source, an onboard battery.

According to another characteristic or an alternative implementation, the method provides to implement a step of installing a specifically banking software application into the main apparatus. The accessory transparently relays transaction exchanges between the apparatus containing the banking application (or any other, more particularly an access control, a payment . . . , transaction application) and the transaction terminal.

A user can thus discretely wear an accessory 2 as a watch and store the main apparatus 1 such as his/her phone in a pocket or a bag. During a transaction, the user places his/her accessory close to the transaction terminal reader. The reader sends an interrogation/reading signal to the main apparatus in the form of radio frequency frames; the accessory can be powered by the energy recovered from the reader radio frequency field. Such energy can be used to process the data and commands (for instance a right or identifier read command, or rights, credits, financial or any other credit tally command).

In the example above, the watch comprises a radio frequency antenna which picks up the radio frequency field conveying the energy and the data and/or the commands from the radio frequency reader. Such energy is used to retrieve the radio frequency data frames and/or commands and to perform an encapsulation processing and to send such frames to the main apparatus 1 using the Bluetooth protocol.

The main apparatus 1 receives the Bluetooth signals from the accessory and then retrieves the radio frequency frames therefrom to transmit same, and for processing by the NFC radio frequency interface means (specifically in the contactless card emulation mode). The radio frequency interface means send the requested information (data, command) back by implementing the previously loaded transaction application. Such information is in turn sent back to the accessory in the form of radio frequency frames encapsulated according to the Bluetooth protocol. The accessory 2 receives the Bluetooth signal, retrieves the radio frequency frames and the corresponding data or commands therefrom and transmits same to the reader more particularly by modulating the reading radio frequency field of the reader.

According to another characteristic or an alternative embodiment, the method preferably provides for a step of initialization (or initiation) of the accessory using the main apparatus or of pairing the accessory using the main apparatus. In the example, the apparatus comprises an initialization and/or pairing application A1.

In the example, a more specifically Bluetooth or wifi pairing is firstly created between the main apparatus and the accessory. The advantage lies in that a data relay is enabled between two apparatuses only if they are close to one another and paired together. Then, if the accessory is stolen, it cannot be used alone without the main apparatus.

The advantage of the invention consists in making it possible to carry out a transaction by presenting the accessory to the transaction terminal instead of the main apparatus. The latter can be concealed or not exposed by being carried inside a garment or a case, a bag . . .

FIG. 2 shows, according to a second embodiment, a transaction system 30 comprising an accessory 12 and a transaction terminal 3. In a second corresponding implementation, the electronic transaction accessory 12 is able to represent a main communication apparatus 10 relative to a transaction terminal 10. For this purpose, the accessory has been configured beforehand and a specific accessory management, pairing application . . . has been installed into the phone; in this case, the phone can substantially be used as the accessory remote screen. The same reference numerals represent the same elements or the like as in the previous figure. Besides, the elements 1, 2 may be identical with or similar to the elements 10, 12 if they have some common functions.

The accessory 12 may comprise, as shown in FIG. 1, the same electronic hardware means specifically for communicating and/or interfacing with the main apparatus 10 and the transaction terminal 3. It may comprise a man/machine interface (a keyboard 7, a screen 8). However, unlike the first embodiment, the second embodiment can do without the main apparatus during a transaction with the transaction terminal.

Another difference with the first embodiment, in this second embodiment, is that the accessory comprises at least one transaction application (for instance A2) described in the first embodiment and contained in identical or similar storage means specifically in an internal memory (SE2) or an external mass storage such as a mass memory card (Mini SIM, SD, micro SD) or a preferably secure USB flash drive. According to an alternative solution, the accessory itself can carry out the function of a USB flash drive comprising one or more wireless communication interfaces. The transaction application in the accessory makes it possible to directly (without the presence of or action by the main apparatus during the transaction) carry out an electronic transaction with a transaction terminal 3 such as a bank terminal (ATM, POS), an access point, a consumer goods vending machine . . .

According to another characteristic or alternative solution of the second embodiment, the method also preferably provides for a step of initialization (or initiation) of the accessory using in particular the main apparatus or of pairing the accessory (specifically with the main apparatus) so that the main apparatus can be represented by the accessory. Initiation can also mean the concept of configuration, training, transfer of means, information, learning, i.e. a training enabling the accessory to carry out a transaction instead of the main apparatus. The apparatus thus preferably also comprises an initialization (initiation) and/or pairing application A1 for an associated accessory 12. As seen from the transaction terminal, the accessory comprises all the required apparatus attributes to carry out the transaction as the transaction apparatus itself (rights, protocol, flash drives, procedures, identification, authentication or other hardware or software element_).

For this purpose, according to a characteristic or an alternative solution of the second embodiment, the method provides that the step of initialization above comprises a phase of transfer or cloning of information (data, functions, program . . . ) selected from:
information on an electronic transaction application (e.g. A2) in the accessory and/or
information IP comprising a PIN code of the main apparatus to the accessory and/or means for managing the entering of a PIN code by the user specifically at the time of the transaction.

The information relating to the transaction application may specifically include the electronic transaction software application itself, as present in the transaction terminal (program, personal data, ID, bank account, address, retailer ID, authorized bank overdraft, credit, debit . . . ). Information may permanently or temporarily include the PIN code or any other authentication element (a fingerprint, a digitized biometric element), as disclosed hereunder.

Thus, thanks to the invention, the accessory can be provided with information or data required to carry out at least one transaction. If the accessory is provided with customized banking applications, a copy of the PIN in the accessory may be sufficient. Such information may come from the main personnel apparatus or any other self-service customization apparatus (an interactive terminal . . . ) capable of transferring information, rights, a subscription, a customization.

For example, a user can program the accessory on the previous day, using the main apparatus so that the accessory can represent the transaction apparatus for accessing the metro within the limits of a round trip and, if appropriate, within set time slots. (For example, the application for buying tickets for the metro or any other means of transportation can be present in the accessory, the PIN can be copied from the phone to the accessory, and erased when the accessory is removed from the handle/hand or at the end of the day or any other period of time thanks to an internal clock.

The user can alternately set the accessory to authorize a purchase for a predetermined maximum amount.

According to an alternative solution, programming can be used to give the PIN code once and/or to authorize a transaction requiring a PIN code within a time slot or with some previously identified transaction terminals (relative to a special organization or located at special places). A GPS (Global Positioning System) or the like may be integrated into the accessory to enable the tracing and authorize or not a transaction according to the authorized zones for carrying out a transaction. The user can thus geographically control the transactions if his/her accessory has been stolen.

The user can thus be free to keep his/her main apparatus such as a mobile phone away from prying eyes. The apparatus can be left at home or in a pocket or a bag, while being active or not. The invention thus makes it possible to avoid the main apparatus to be stolen when it is exposed during a transaction. The user can chose whether the apparatus 1 and the accessory 2 will have to be close or not to carry out transactions.

According to another characteristic or an alternative embodiment, the method provides that at least one of the steps of initialization/initiation or of pairing above comprises a phase of launching an application for driving the accessory from the main apparatus. Such launching can be executed, for example, through the user's selection from a menu displayed by the main apparatus. Parameters can be submitted by the menu such as an authorized amount, a number of transactions with a PIN authentication and/or a biometric authentication.

Thus, the user may or may not, as desired, step up or down the security level implemented in particular for his/her financial or bank transactions depending on the issues involved or on the dangerousness of the place where the transaction is carried out or on the doubt as to whether the third party or the terminal with whom/which the electronic transaction is carried out can be trusted or not, or the time available to the user during the transaction.

Thus, the invention makes it possible to control the implementation of the transaction application (which can be standardized and unchangeable) transferred to the accessory via another software control application which has been associated therewith and set in the accessory. The control can more particularly relate to a geographical area, a period of time or the conditions (maximum amount, security level, authentication, identification of the authorized transaction terminals, transaction type including for example access to means of transportation, food or clothing purchase, payment in a restaurant, at a hotel, for a taxi . . . ) in which the transaction can be carried out, as authorized by the user.

The control software application can implement a comparative test of location parameters more particularly supplied by an internal GPS (received from outside). The test may compare time parameters provided in particular by an internal clock. The test may compare an authorized limit of transaction amount (specifically programmed internally), an identification of an authorized or predefined terminal. The parameters can include or define the object of the transaction, a place or a geographical zone of the transaction, the identification of contractual third parties acting in the transaction.

The invention makes it possible to transfer or duplicate transaction rights to one or more accessory(ies) from a main apparatus. Thus, for example, a person having a main apparatus with an electronic wallet application, can delegate or transfer, on a daily basis, to two children each having an accessory, a certain amount, for some specific use, for example, two Euros to one child for the college drink dispenser, with an identifier, and six Euros for a meal at the college canteen, and 2 Euros to the other child for a return ticket on an identified transportation line, and 5 Euros for other expenses within a geographical area limited to a city and its whereabouts. This is again a function of the invention for the distribution of payment units, from a parent to his/her children, but with a higher security level as regards theft and parental control on the use of such units.

The accessory can keep track of unauthorized transactions attempted by a person holding the accessory so as to inform the holder of the apparatus upon a subsequent collection or exchange of information between the main apparatus and an accessory.

If need be, control application checking parameters AC or 16 for the implementation of the transaction application can be set on or entered directly into the accessory. For this purpose, the accessory may include a man/machine interface (a keyboard, a touch screen or a normal screen, a fingerprint sensor. . . ).

According to another characteristic or an alternative implementation applicable to both embodiments above, the method provides that the above drive application can capture via any man/machine interface (MMI) on the main apparatus (a keyboard, a touch screen, a voice recognition system . . . ) a (specifically encrypted or coded) PIN code or equivalent required for a future transaction and send it safely to the accessory to authorize a future or in-progress transaction. The encrypted or coded PIN code or equivalent can be stored in the accessory and before or at the time of the transaction be issued, decrypted or decoded.

According to an alternative solution, the terminal requests the user to enter the PIN code, during the transaction, and transmits same to the accessory for comparison purposes, and returns a validation to the bank terminal.

According to another characteristic or an alternative implementation applicable to all described embodiments, the method preferably provides that the transaction will be authorized by the user's voluntary action on a switch or by a biometric authentication by the accessory. As mentioned above, the authentication can be entered on the transaction terminal submitting the data for validation to the accessory (such as the PIN code for a credit card). The PIN code may also be entered directly on the accessory, as described above.

The invention may provide for a safety feature to be transferred to the accessory, for instance a voluntary biometric authentication (PIN code) at the accessory to enable the accessory to relay a response from the main apparatus or any other exchange leading to complete a transaction with the transaction terminal. This makes it possible not to take the main apparatus out to enter a PIN code or to otherwise authenticate oneself.

Once initialized, programmed, temporarily customized, the apparatus 10 may be left at home while the accessory is used outside, since special features have been transferred thereto. The accessory can have advanced communications features such as mobile telephony, wifi like the main apparatus. The accessory makes it possible to use fair and necessary resources or rights from the main apparatus for a specified period of time or according to any other specified criteria. The accessory is in principle less costly and allows customized security with optimized fineness according to the user's wishes that cannot be authorized by the main apparatus.

In operation, during a transaction, a person holding the accessory pre-programmed in particular using the main apparatus, stands in front of the transaction terminal. An exchange is carried out between the accessory and the transaction terminal if a test on one of the predetermined settings is successful. The checking may be carried out either before starting a transaction, for example, the NFC function is inhibited as long as the setting is not satisfactory (e.g. the tracing, the time of the transaction out of an authorized slot).

The checking may be carried out during the transaction, for instance, checking is carried out after receiving a request for debiting a certain amount, with a terminal identifier. The checking program compares the amount requested relative to the amount authorized and programmed in the accessory and/or compares the terminal identifier to a series of authorized IDs programmed in the accessory.

Checking may also be carried out upon completion of the transaction: for example, a PIN code has to be submitted to validate the transaction. The test compares, in the accessory, the number of times the PIN code has been used, specifically on the same day relative to an authorized number programmed in the accessory.

If one or more of the above checking tests is/are satisfactory, the transaction continues.

Thus, according to one aspect, the invention may have the advantage of adding a control software layer or control material resources in the apparatus for using an application without having to change the application itself.

If need be, in some other cases, the application can be directly modified, and completed using the main apparatus if it is designed therefor.

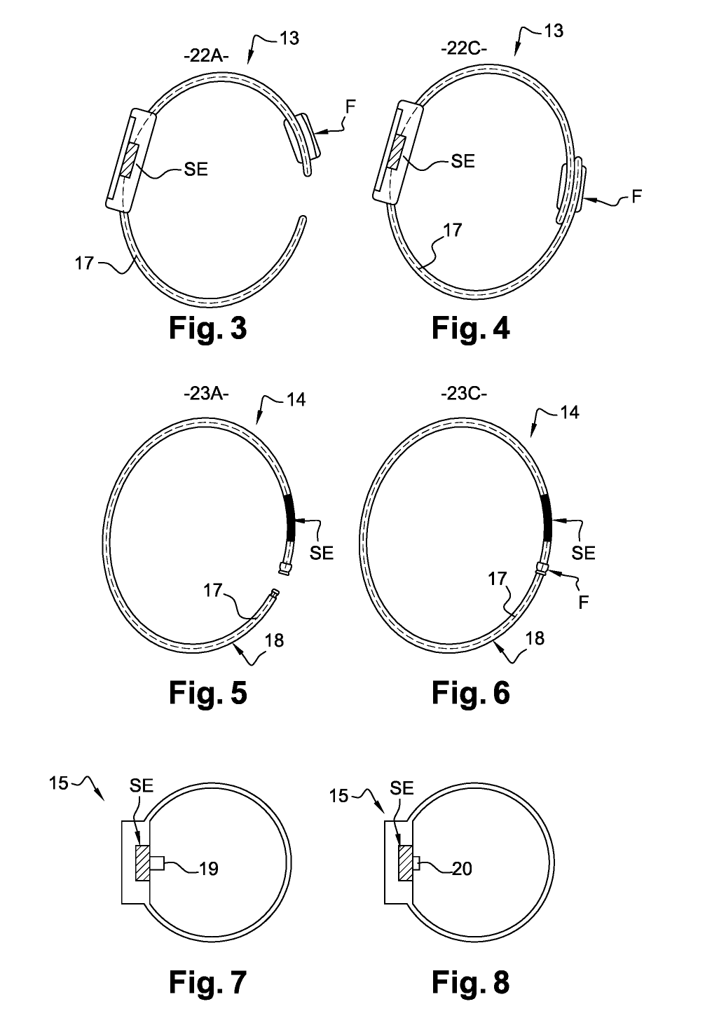

In FIGS. 3 to 8, the accessory is respectively a clock 13, a bracelet (a bangle) 14 or a ring 15. The accessory comprises an electronic SE circuit and/or hardware means like the accessories in the preceding figures. The accessory may preferably comprise means for detecting the user's presence or the authentication of the latter (an electric circuit along the parts 17 of the watchband or 18 of the bangle). The watchstrap and the ring can be closed or locked using any closure/locking system F and a mechanism (not shown) may be included in the SE component may detect the closing/locking and opening/unlocking of the bracelet or the ring. The mechanism may be a simple specifically capacitive, electric, or optical switch.

In FIGS. 7, 8, the ring comprises a switch button which closes the circuit 19 in pressed position, when introduced on a finger and which relaxes and opens 20 the circuit when the SE circuit is removed from the finger.

Thus, once programmed or initialized, the accessory can relay or represent the transaction apparatus when the accessory is in the user's presence (the accessory in the closed position of a bracelet or a bangle or with the ring switch pressed).

But if stolen, the accessory is separated from the user, particularly by opening the bracelet or the ring, which creates the opening of the safety circuit. Such opening is detected by a detection circuit included in the accessory. The detection circuit causes a total or partial inhibition of the functions of the accessory (for instance, the transaction or the communication function . . . ). The accessory can thus be made unusable until the next initialization (initiation) or reactivation using an associated main apparatus provided for this purpose.

According to another aspect, the invention may relate to a method for carrying out an electronic transaction between a main communication apparatus 1, 10 and a transaction terminal 3, wherein the accessory itself becomes a main apparatus. As a matter of fact, in this case the accessory can be programmed directly by the user or using another apparatus, specifically a terminal for loading or downloading data or information applications, or any computer. The accessory can also delegate rights to other accessories or to the main apparatus by reversing the roles, specifically by transferring a complete software application, or restoring rights or unused units to a main apparatus.

Another system authorizing transactions can only be seen between the main apparatus 10 and an accessory 12 wherein above mentioned transactions, i.e.

restitution, rights, units, transfer of an application can be performed.

Although the accessory described above has a different format from a smart card, the accessory itself may comprise such a contactless chip card and keep it invisible (hidden, embedded).

1. A method for carrying out an electronic transaction between a main or accessory communication apparatus and a transaction terminal, wherein:
a smart portable accessory is provided, which has a different format from a standardized chip card format, and is capable of relaying the transaction or of representing said main apparatus relative to a transaction terminal, and
the transaction is carried out by only presenting said accessory, instead of the main apparatus, to the transaction terminal.

2. A method according to claim 1, wherein a software application controls the implementation of a transaction software application.

3. A method according to claim 1, comprising a step of installing a banking application into the main apparatus, with the accessory transparently relaying the transaction between the main apparatus and the transaction terminal.

4. A method according to claim 1, comprises a step of initialization/initiation of the accessory using the main apparatus or of pairing the accessory using the main apparatus.

5. A method according to claim 4, wherein the step of initialization/initiation comprises a phase of transfer/cloning of information contained in the apparatus to the accessory, with said information being selected from:
information on an electronic transaction application in the accessory and/or
information comprising a PIN code.

6. A method according to claim 4, wherein the step of initialization comprises a phase of launching an application for the driving of the accessory by the main apparatus.

7. A method according to claim 6, wherein the step of initialization/initiation captures a PIN code or the like required for a future transaction, via the main apparatus, and transmits it safely to the accessory to enable a future or an in-progress transaction.

8. A method according to claim 7, wherein the accessory is provided with communication means so configured as to relay data and control commands between the main apparatus and the terminal.

9. A method according to claim 7, wherein the transaction is authorized by the user's voluntary action on a switch or a biometric authentication by the accessory.

10. A method according to claim 1, comprising a software application for controlling the implementation of a transaction software application particularly as regards a geographical area, a time period or how to carry out the transaction.

11. A method according to claim 10, wherein the control software application implements a comparative test on location parameters supplied by an internal GPS, time parameters supplied in particular by an internal clock, a transaction amount limit specifically programmed internally, an identification of the authorized or pre-set terminal, parameters defining the object of the transaction, the geographic place of the transaction, a parameter identifying a contractual third party acting in the transaction.

12. A system for carrying out an electronic transaction between a main or accessory communication apparatus and a transaction terminal,
comprising:
a smart portable accessory, which has a different format from a standardized chip card format, capable of relaying the transaction or representing said main apparatus relative to a transaction terminal, and
communication and initialization/initiation means in the main apparatus to initialize/initiate the portable accessory and means for the communication of the accessory with a transaction terminal for carrying out the electronic transaction instead of the main apparatus, through the presentation of the accessory only to the transaction terminal.
